(19) United States
(12) Patent Application Publication
(10) Pub. No.: US 2023/0118639 A1
(43) Pub. Date: Apr. 20, 2023

(54) REUSE DETERMINATION SYSTEM, REUSE DETERMINATION METHOD AND COMPUTER READABLE STORAGE MEDIUM

(71) Applicant: HONDA MOTOR CO.,LTD., Tokyo (JP)

(72) Inventors: Yasuhito TAKEI, Saitama (JP); Ryosuke ITOYAMA, Saitama (JP); Shogo TAKANO, Saitama (JP); Kazuki SAKURAI, Saitama (JP)

(21) Appl. No.: 17/960,152

(22) Filed: Oct. 5, 2022

(30) Foreign Application Priority Data
Oct. 20, 2021 (JP) 2021-171761

(51) Int. Cl. G07C 5/02; G06Q 10/00

(52) U.S. Cl. CPC G07C 5/02; G06Q 10/30

(57) ABSTRACT

A reuse determination system of a power unit for propelling a vehicle includes an acquisition section configured to acquire operation history data including torque data and number of rotations data of the rotating electrical machine, an estimation section configured to estimate a load of each of a plurality of components constituting the power unit, based on at least one of the torque data or the number of rotations data, and a determination section configured to compare, for each of the plurality of components constituting the power unit, each load estimated by the estimation section with a threshold set for each of the plurality of components and determine that the power unit is to be reused, when the load of each of the plurality of components estimated by the estimation section is equal to or less than the threshold set for each of the plurality of components.

The contents of the following Japanese patent application(s) are incorporated herein by reference:

NO. 2021-171761 filed on Oct. 20, 2021.

### BACKGROUND

### 1. Technical Field

The present invention relates to a reuse determination system, a reuse determination method and a computer readable storage medium.

### 2. Related Art

Patent Document 1 discloses a technology for providing a design guide for easily and efficiently reducing various costs and waste loss of recycle processing when designing a globally expanding product to be shipped to a plurality of countries.

### PRIOR ART DOCUMENT

### Patent Document

Patent Document 1: Japanese Patent Application Publication No. 2010-170289

### BRIEF DESCRIPTION OF THE DRAWINGS

FIG. 1 is a conceptual view of reuse processing of a power unit provided to a vehicle.

FIG. 2 schematically shows a block configuration of a reuse determination system 40.

FIG. 3 is an example of a flowchart relating to a reuse determination method that is executed by the reuse determination system 40.

FIG. 4 is an example of a flowchart relating to a reuse determination method of a gearbox 20.

FIG. 5 is an example of a flowchart relating to a reuse determination method of a rotating electrical machine 30.

FIG. 6 is an example of a flowchart relating to a reuse determination method of a rotor.

FIG. 7 is an example of a flowchart relating to a reuse determination method of a stator.

FIG. 8 shows an example of a computer 2000 where a plurality of embodiments of the present invention may be entirely or partially embodied.

### DESCRIPTION OF EXEMPLARY EMBODIMENTS

Hereinafter, the present invention will be described through embodiments of the invention, but the following embodiments do not limit the invention according to claims. In addition, not all combinations of features described in the embodiments are essential to the solving means of the invention.

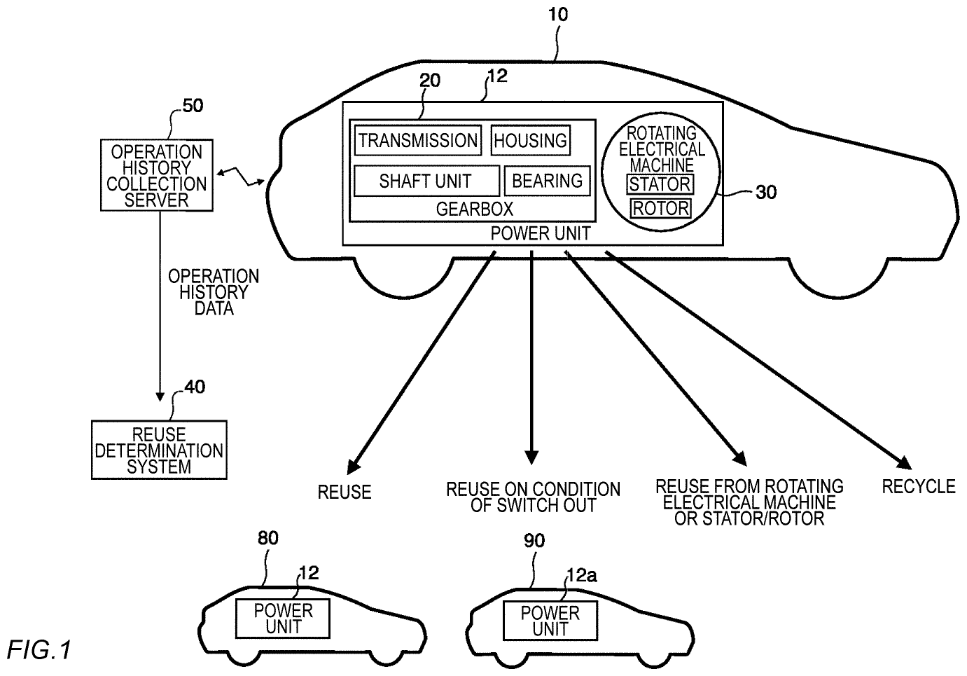

FIG. 1 is a conceptual view of reuse processing of a power unit provided to a vehicle. The vehicle 10 is, for example, an electric vehicle. The vehicle 10 may be a hybrid electric vehicle or the like.

The vehicle 10 includes a power unit 12 for propelling the vehicle 10. The reuse determination system 40 is configured to determine reuse of the power unit 12. The power unit 12 includes a gearbox 20 and a rotating electrical machine 30. The gearbox 20 includes a power transmission device, a housing configured to accommodate at least the power transmission device, a shaft unit, and a bearing. The power transmission device may be a device configured to perform power transmission of a fixed stage having no speed change function or a device having a speed change function. When the power transmission device is a device having a speed change function, the power transmission device may include a transmission. The bearing is a component configured to support a shaft that is driven by the rotating electrical machine 30. The shaft unit includes a shaft, a boot and a joint. The shaft unit and the bearing are examples of a transmission device for transmitting power from the rotating electrical machine 30 and the power transmission device to a driven part such as a wheel. The rotating electrical machine 30 includes a stator and a rotor. The vehicle 10 is configured to transmit, to an operation history collection server 50, operation history data including measured values of a torque, a number of rotations, a current, and a temperature of the rotating electrical machine 30 while the rotating electrical machine 30 is operating.

When the vehicle 10 is taken over by a dealer due to replacement or the like, the reuse determination system 40 is configured to acquire the operation history data of the rotating electrical machine 30 from the operation history collection server 50 and to perform determination as to reuse of the power unit 12. Specifically, the reuse determination system 40 is configured to calculate a load of each of the power transmission device, the housing, the bearing, the shaft and the joint, which are components constituting the gearbox 20, and the rotor and the stator, which are components constituting the rotating electrical machine 30, based on the operation history data. For example, the reuse determination system 40 is configured to calculate a cumulative damage degree of each component, as the load of each component.

For each of the power transmission device, the housing, the bearing, the shaft, the joint, the rotor, and the stator, a load threshold that is used for determining whether to reuse each component is set. The reuse determination system 40 is configured to determine that a component whose load is equal to or less than a threshold is to be reused. When the reuse determination system 40 determines that all of the power transmission device, the housing, the bearing, the shaft, and the joint are to be reused, the reuse determination system determines that the gearbox 20 is to be reused. When the reuse determination system 40 determines that a part of the power transmission device, the housing, the bearing, the shaft and the joint is not to be reused, the reuse determination system determines that the gearbox 20 is to be reused (reused on condition of component replacement) by replacing the component determined not to be reused. In addition, when the reuse determination system 40 determines that the rotor and the stator are to be reused, the reuse determination system determines that the rotating electrical machine 30 is to be reused.

When the reuse determination system 40 determines that the gearbox 20 is to be reused and also determines that the rotating electrical machine 30 is to be reused, the reuse determination system determines that the power unit 12 is to be reused. The power unit 12 determined to be reused is used as a power unit for another vehicle 80.

When the reuse determination system 40 determines that the gearbox 20 is to be reused on condition of component replacement and also determines that the rotating electrical machine 30 is to be reused, the reuse determination system determines that the power unit 12 is to be reused on condition of component replacement. The power unit 12 determined to be reused on condition of component replacement is subjected to component replacement, and is used as a power unit for another vehicle 90, as a power unit 12a.

When the reuse determination system 40 determines that the gearbox 20 is not to be reused and the rotating electrical machine 30 is to be reused, or when the reuse determination system determines that only one of the rotor and the stator of the rotating electrical machine 30 is to be reused, any one of the rotating electrical machine 30, the rotor and the stator is to be reused. For example, when the reuse determination system 40 determines that the rotating electrical machine 30 is to be reused, the entire rotating electrical machine 30 is to be reused, and when the reuse determination system determines that only one of the rotor and the stator is to be reused, one component determined to be reused is to be reused and the other component is to be recycled.

When the reuse determination system 40 determines that both the rotor and the stator of the rotating electrical machine 30 are not to be reused, the rotor and the stator of the rotating electrical machine 30 are to be recycled.

According to the reuse determination system 40, it is possible to determine whether to reuse the entire power unit 12 or each component of the rotating electrical machine 30, taking into consideration the load of each component of the gearbox 20 and the rotating electrical machine 30. Therefore, it is possible to suppress the power unit 12 from being uselessly brought on recycling.

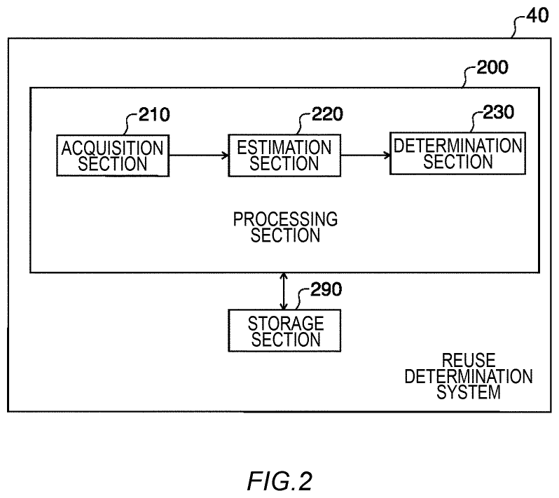

FIG. 2 schematically shows a block configuration of the reuse determination system 40. The reuse determination system 40 includes a processing section 200 and a storage section 290.

The storage section 290 is implemented with a non-volatile storage medium. The processing section 200 is implemented by a circuit such as an arithmetic processing unit including a processor, for example. The processing section 200 is configured to perform processing by using information stored in the storage section 290.

The processing section 200 includes an acquisition section 210, an estimation section 220, and a determination section 230. The acquisition section 210 is configured to acquire operation history data including torque data and number of rotations data of the rotating electrical machine 30. The estimation section 220 is configured to estimate a load of each of a plurality of components constituting the power unit, based on at least one of the torque data or the number of rotations data. The determination section 230 is configured to compare, for each of the plurality of components constituting the power unit, each load estimated by the estimation section 220 with a threshold set for each component. The determination section 230 is configured to determine that the power unit is to be reused, when the load of each of the plurality of components estimated by the estimation section 220 is equal to or less than the threshold set for each component. In addition, the determination section 230 is configured to determine that the power unit is to be subjected to component replacement and to be reused, when there exists a component for which a load exceeding a threshold set for each component of the plurality of components is estimated among the plurality of components. Note that, in the present embodiment, the components of the power unit 12 to be subjected to the load determination are the power transmission device, the housing, the bearing, the shaft, the boot and the joint of the gearbox 20, and the rotor and the stator included in the rotating electrical machine 30.

The estimation section 220 is configured to estimate a load of each of the power transmission device, the housing and the transmission device, based on the torque data and the number of rotations data. The determination section 230 is configured to compare, for each of the power transmission device, the housing and the transmission device, each load estimated by the estimation section 220 with a threshold set for each component. The determination section 230 is configured to determine that the gearbox 20 is to be reused, when the load of each of the power transmission device, the housing, and the transmission device is equal to or less than the threshold set for each component. The determination section 230 is configured to determine that the gearbox 20 is to be subjected to component replacement and the gearbox 20 is to be reused, when the load of at least one of the power transmission device, the housing, or the transmission device exceeds the threshold.

The determination section 230 is configured to determine that the gearbox 20 is not to be reused, when a load of a member, which exceeds a predetermined number, of the power transmission device, the housing, and the transmission device exceeds the threshold set for each component. The determination section 230 is configured to determine that a component whose load exceeds a threshold is to be subjected to component replacement and the gearbox 20 is to be reused, when a number of a component whose load does not exceed the threshold, is equal to or less than a predetermined number.

The determination section 230 is configured to acquire a number of times that the torque of the rotating electrical machine 30 exceeds a predetermined torque value, based on the torque data, and to determine that the gearbox 20 is not to be reused, when the number of times that the predetermined torque value is exceeded exceeds a predetermined allowable value.

The estimation section 220 is configured to acquire a number of times that the number of rotations of the rotating electrical machine 30 exceeds a predetermined number of rotations, based on the number of rotations data, and to estimate a load of a component constituting the rotating electrical machine 30, based on the number of times. The determination section 230 is configured to determine that the rotating electrical machine 30 is to be reused, when the load of the component constituting the rotating electrical machine 30 is equal to or less than a predetermined threshold. The determination section 230 is configured to determine that the rotating electrical machine 30 is not to be reused, when the load of the component constituting the rotating electrical machine 30 exceeds the threshold.

The estimation section 220 is configured to acquire a number of times that the number of rotations of the rotating electrical machine 30 exceeds a predetermined number of rotations, based on the number of rotations data, and to estimate a load of a component constituting the rotating electrical machine 30, based on the number of times. The determination section 230 is configured to determine that the rotating electrical machine 30 is to be reused, when the load of the component constituting the rotating electrical machine 30 is equal to or less than a predetermined threshold, and to determine that the rotating electrical machine 30 is not to be reused, when the load of the component constituting the rotating electrical machine 30 exceeds the threshold. The determination section 230 is configured to determine that the power unit is to be reused, when it is determined that the rotating electrical machine 30 and the gearbox 20 are to be reused.

The estimation section 220 is configured to acquire a number of times that the number of rotations of the rotating electrical machine 30 exceeds a predetermined number of rotations, based on the number of rotations data, and to estimate a load of the rotor provided to the rotating electrical machine 30, based on the number of times. The determination section 230 is configured to determine that the rotor is to be reused, when the load of the rotor is equal to or less than a predetermined threshold. The determination section 230 is configured to determine that the rotor is not to be reused, when a load of the rotor exceeds the threshold.

The operation history data further includes current data and temperature data of the rotating electrical machine 30. The estimation section 220 is configured to estimate a demagnetization amount of a magnet included in the rotor, further based on the current data and the temperature data. The determination section 230 may be configured to determine that the rotor is to be reused, when the load of the rotor is equal to or less than a predetermined threshold and the demagnetization amount of the magnet is equal to or less than a predetermined threshold.

The operation history data may further include the temperature data of the rotating electrical machine 30. The estimation section 220 is configured to estimate a load of a resin member included in the stator of the rotating electrical machine 30, based on the temperature data. The determination section 230 is configured to determine that the stator is to be reused, when the load of the resin member is equal to or less than a predetermined threshold. The determination section 230 is configured to determine that the stator is not to be reused, when the load of the resin member exceeds the threshold. The resin member may include a sealing resin for a stator coil, a varnish, or the like.

The determination section 230 is configured to determine that the rotating electrical machine 30 is to be reused, when it is determined that the rotor and the stator are to be reused.

The determination section 230 is configured to decide a reuse destination of the power unit determined to be reused, based on the load of each of the plurality of components estimated by the estimation section 220.

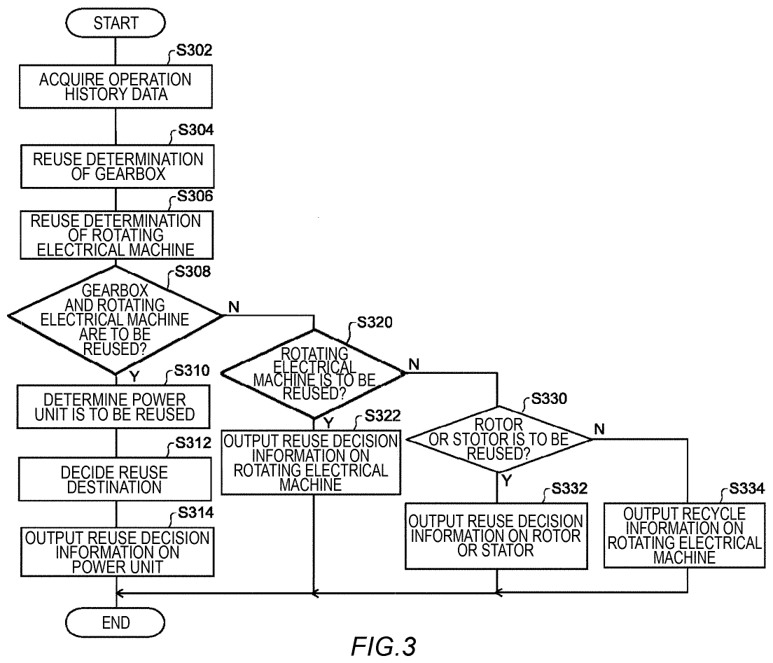

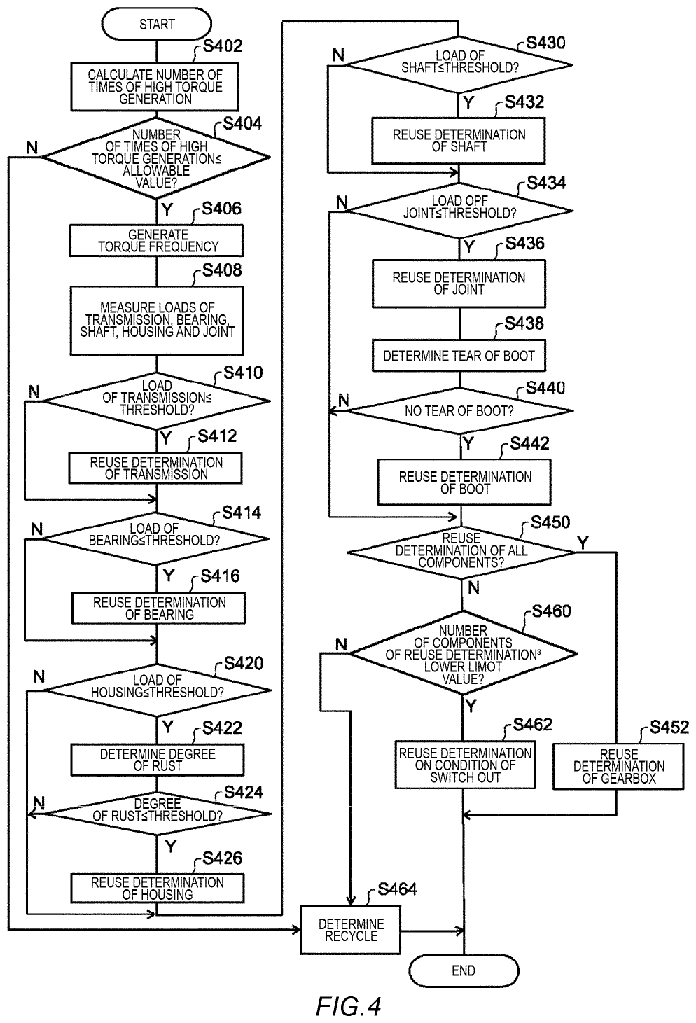

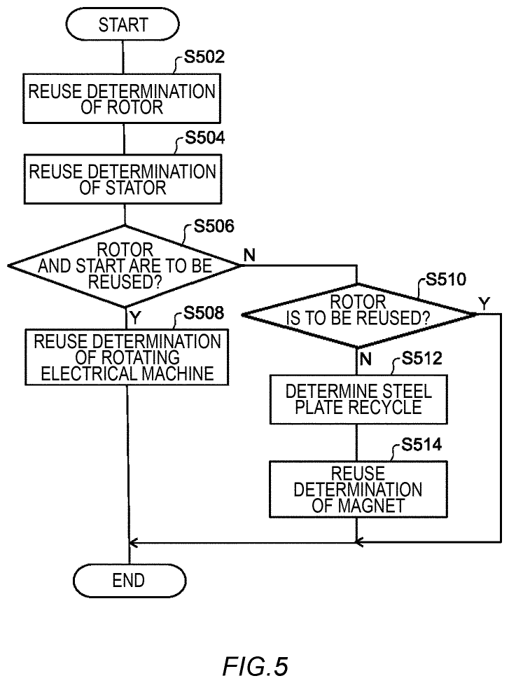

FIG. 3 is an example of a flowchart relating to a reuse determination method that is executed by the reuse determination system 40. In S302, the acquisition section 210 acquires operation history data from the operation history collection server 50. In S304, the determination section 230 determines whether to reuse the gearbox 20. Details of the processing of S304 will be described in connection with FIG. 4. In S306, the determination section 230 determines whether to reuse the rotating electrical machine 30. Details of the processing of S306 will be described in connection with FIGS. 5 to 7.

In S308, the determination section 230 judges whether it has been determined that both the gearbox 20 and the rotating electrical machine 30 are to be reused. When it has been determined that both the gearbox 20 and the rotating electrical machine 30 are to be reused, it is determined that the power unit 12 is to be reused. In S312, the determination section 230 decides a reuse destination of the power unit. The determination section 230 decides the reuse destination, based on the cumulative damage degrees of the components constituting the power unit 12. For example, when the highest cumulative damage degree among the cumulative damage degrees of the plurality of components constituting the power unit 12 is equal to or less than a predetermined value, the determination section 230 decides that the reuse destination of the power unit 12 is for a semi-new vehicle or for repair of a sold vehicle. On the other hand, when the highest cumulative damage degree among the cumulative damage degrees of the plurality of components constituting the power unit 12 exceeds the predetermined value, the determination section 230 determines that the reuse destination of the power unit 12 is for a circulation type vehicle.

Following S312, in S314, the determination section 230 outputs reuse decision information on the power unit 12 to an outside in association with identification information on the power unit 12. The reuse decision information is used in a reuse process of the power unit 12. In addition, the reuse decision information is used for purchase assessment or the like of the vehicle 10.

When it has been judged that at least one of the gearbox 20 or the rotating electrical machine 30 is determined as not to be reused, the processing proceeds from the judgment of S308 to S320 and the determination section 230 judges whether it has been determined that the rotating electrical machine 30 is to be reused. When it has been determined that the rotating electrical machine 30 is to be reused, in S322, the determination section 230 outputs reuse decision information on the rotating electrical machine 30 in association with the identification information on the power unit 12. The above reuse decision information is used in a reuse process of the rotating electrical machine 30. In addition, the reuse decision information is used for purchase assessment or the like of the vehicle 10.

When it has not been determined that the rotating electrical machine 30 is to be reused, the processing proceeds from S320 to S330, and the determination section 230 judges whether it has been determined that either the rotor or the stator is to be reused. When it has been determined that either the rotor or the stator is to be reused, the determination section 230 outputs reuse decision information on the rotor or stator in association with the identification information on the power unit 12. The above reuse decision information is used in a reuse process of the rotor or stator. In addition, the reuse decision information is used for purchase assessment or the like of the vehicle 10.

When it has been determined that neither the rotor nor the stator is to be reused, in S334, recycle decision information on the rotating electrical machine 30 is output in association with the identification information on the power unit 12. The above recycle decision information is used in a recycle process of the rotor and the stator. In addition, the recycle decision information is used for purchase assessment or the like of the vehicle 10.

FIG. 4 is an example of a flowchart relating to a reuse determination method of the gearbox 20. The processing of this flowchart can be applied to the processing of S304 in FIG. 3.

In S402, the determination section 230 calculates a number of times of high torque generation, based on the torque data of the rotating electrical machine 30. The determination section 230 calculates the number of times of high torque generation by counting a number of times that a predetermined torque value is exceeded. In S404, the determination section 230 judges whether the number of times of high torque generation is equal to or less than an allowable value. When the number of times of high torque generation is equal to or less than the allowable value, the processing is caused to proceed to S406. When the number of times of high torque generation exceeds the allowable value, the processing is caused to proceed to S464.

In S406, the estimation section 220 generates torque frequency information. The torque frequency information is calculated based on the torque data and the number of rotations data. The torque frequency information is information indicating a correspondence relationship among a torque value, a number of rotations, and a time. The torque frequency information is used so as to calculate the cumulative damage degree of each component.

In S408, the estimation section 220 estimates a load of each of the power transmission device, the bearing, the shaft, the housing, and the joint, based on the torque frequency information. For example, the estimation section 220 estimates the cumulative damage degree of each of the power transmission device, the bearing, the shaft, the housing, and the joint.

In S410, the determination section 230 judges whether the load of the power transmission device is equal to or less than a threshold set for the power transmission device. When the load of the power transmission device is equal to or less than the threshold, the determination section 230 determines that the power transmission device is to be reused (S412). On the other hand, when the load of the power transmission device exceeds the threshold, the processing is caused to proceed to S414.

In S414, the determination section 230 judges whether the load of the bearing is equal to or less than a threshold set for the bearing. When the load of the bearing is equal to or less than the threshold, the determination section 230 determines that the bearing is to be reused (S416). On the other hand, when the load of the bearing exceeds the threshold, the processing is caused to proceed to S420.

In S420, the determination section 230 judges whether the load of the housing is equal to or less than a threshold set for the housing. When the load of the housing is equal to or less than the threshold, the processing is caused to proceed to S422. On the other hand, when the load of the housing exceeds the threshold, the processing is caused to proceed to S430. In S422, the determination section 230 determines a degree of rust of the housing. As an example, the determination section 230 may determine the degree of rust by analyzing an image of the housing. The determination section 230 may acquire a visual inspection result of the housing and determine the degree of rust, based on the inspection result. The degree of rust may be determined based on an area of rust generated, a color of rust, and the like. The determination section 230 determines in S424 whether the degree of rust is equal to or less than a threshold. When the degree of rust is equal to or less than the threshold, the processing is caused to proceed to S426 to determine that the housing is to be reused, and when the degree of rust exceeds the threshold, the processing is caused to proceed to S430. Note that, the determination section 230 may determine presence or absence of oil leakage, in addition to the degree of rust of the housing, and may determine that the housing is to be reused, when there is no oil leakage.

In S430, the determination section 230 judges whether the load of the shaft is equal to or less than a threshold set for the shaft. When the load of the shaft is equal to or less than the threshold, the determination section 230 determines that the shaft is to be reused (S432). On the other hand, when the load of the shaft exceeds the threshold, the processing is caused to proceed to S434.

In S434, the determination section 230 judges whether the load of the joint is equal to or less than a threshold set for the joint. When the load of the joint is equal to or less than the threshold, the processing is caused to proceed to S436. On the other hand, when the load of the joint exceeds the threshold, the processing is caused to proceed to S450. In S436, the determination section 230 determines that the joint is to be reused. Subsequently, in S438, the determination section 230 determines a tear of the boot. As an example, the determination section 230 may determine the tear of boot by analyzing an image of the boot. The determination section 230 may acquire a visual inspection result of the boot and determine the tear of the boot, based on the inspection result. The determination section 230 determines in S440 whether there is a tear of the boot. When there is no tear of the boot, the processing is caused to proceed to S442 to determine that the boot is to be reused, and when there is a tear of the boot, the processing is caused to proceed to S450.

In S450, it is judged whether it has been determined that all of the power transmission device, the bearing, the shaft, the housing, the joint and the boot are to be reused. When it has been determined that all of the power transmission device, the bearing, the shaft, the housing, the joint, and the boot are to be reused, it is determined in S452 that the gearbox 20 is to be reused, and the processing of this flowchart is ended. When it has been determined that at least one of the power transmission device, the bearing, the shaft, the housing, the joint, and the boot is not to be reused, it is determined in S460 whether a number of components determined to be reused is equal to or larger than a predetermined lower limit number. When the number of components determined to be reused is equal to or larger than the lower limit number, the determination section 230 determines in S462 that reuse will be made on condition of component replacement, and the processing of this flowchart is ended. On the other hand, when the number of components determined to be reused is less than the lower limit number, the determination section 230 determines in S464 that the rotating electrical machine 30 is to be recycled without being reused, and the processing of this flowchart is ended.

FIG. 5 is an example of a flowchart relating to a reuse determination method of the rotating electrical machine 30. The processing of this flowchart can be applied to the processing of S306 in FIG. 3.

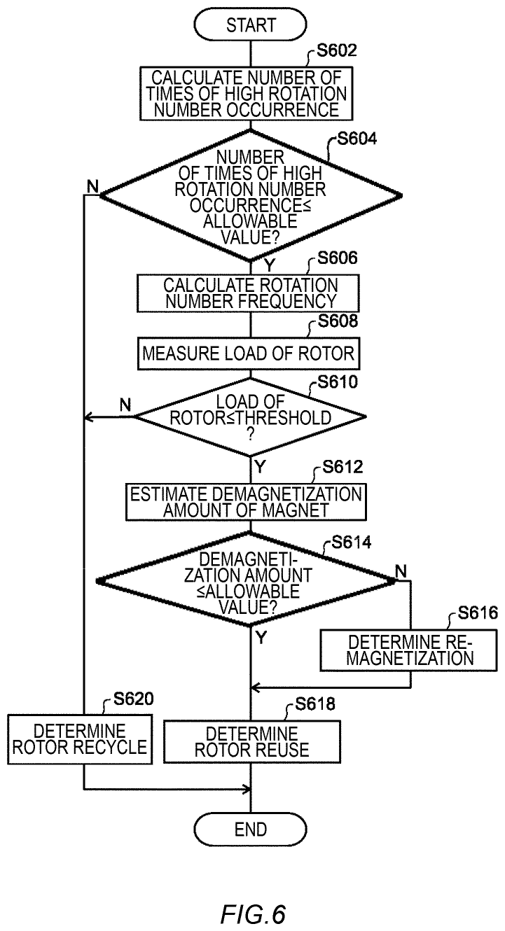

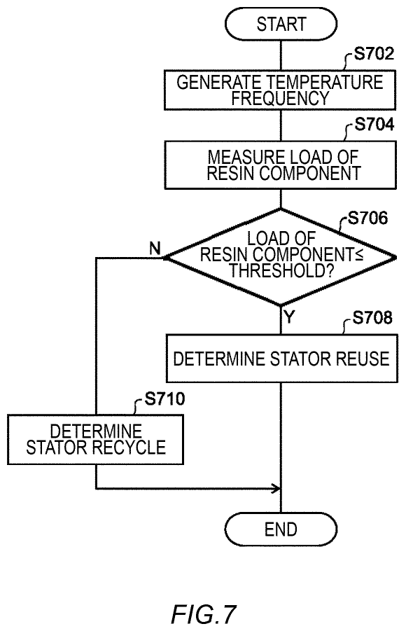

In S502, the determination section 230 determines whether to reuse the rotor of the rotating electrical machine 30. Details of the processing of S502 will be described in connection with FIG. 6. In S504, the determination section 230 determines whether to reuse the stator of the rotating electrical machine 30. Details of the processing of S504 will be described in connection with FIG. 7. In S506, the determination section 230 judges whether it has been determined that both the rotor and the stator are to be reused. When it has been determined that both the rotor and the stator are to be reused, the determination section 230 determines in S508 that the rotating electrical machine 30 is to be reused.

On the other hand, when it has been determined that only one of the rotor and the stator is to be reused, it is judged in S510 whether it has been determined that the rotor is to be reused. When it has been determined that the rotor is to be reused, the processing of this flowchart is ended. When it has been determined that the rotor is not to be reused, it is determined in S512 that an electromagnetic steel sheet of the rotor is to be recycled. Further, in S514, it is assumed to perform determination as to whether a magnet included in the rotor is to be reused, and the processing of this flowchart is ended.

Note that, the determination as to whether the magnet is to be reused is executed after the magnet is taken out from the rotor. For example, the determination as to whether the magnet is to be reused is made based on whether a size of the magnet matches a predetermined size, whether a weight of the magnet matches a predetermined weight, and a visual inspection result. When it has been determined that the magnet is to be reused, the magnet is to be reused as a magnet for electrically powered equipment other than the vehicle. When it has been determined that the magnet is not to be reused, the magnet taken out at a recycling plant is subjected to melting and filtering in a melting process, and extraction, crystallization, filtering and firing in a purification process, and is then regenerated into a magnet.

FIG. 6 is an example of a flowchart relating to a reuse determination method of the rotor. The processing of this flowchart can be applied to the processing of S502 in FIG. 5. In S602, the determination section 230 calculates a number of times of high number of rotations occurrence, based on the number of rotations data. For example, the determination section 230 calculates the number of times of high number of rotations occurrence by counting a number of times that the number of rotations of the rotating electrical machine 30 exceeds a predetermined number of rotations, based on the number of rotations data.

In S604, the determination section 230 judges whether the number of times of high number of rotations occurrence is equal to or less than an allowable value. When the number of times of high number of rotations occurrence is equal to or less than the allowable value, the processing is caused to proceed to S606. When the number of times of high number of rotations occurrence exceeds the allowable value, the processing is caused to proceed to S620.

In S606, the estimation section 220 generates number of rotations frequency information. The number of rotations frequency information is calculated based on the number of rotations data. The number of rotations frequency information is information indicating the number of rotations and a number of times of variation of the number of rotations at a time of variation of the number of rotations. For example, the number of rotations frequency information is information indicating the number of rotations and a number of times of variation thereof at a time when the number of rotations of the rotating electrical machine 30 varies from ascending to descending. The number of rotations frequency information is used so as to calculate the cumulative damage degree of the rotor. In S608, the estimation section 220 estimates a load of the rotor, based on the number of rotations frequency information. For example, the estimation section 220 estimates the cumulative damage degree of the rotor.

In S610, the determination section 230 judges whether the load of the rotor is equal to or less than a threshold set for the rotor. When the load of the rotor is equal to or less than the threshold, in S612, the estimation section 220 estimates a demagnetization amount of the magnet included in the rotor, based on the current value data and the temperature data. For example, the estimation section 220 estimates the demagnetization amount of the magnet included in the rotor, based on a maximum value of the current value and a maximum value of the temperature. In S612, the determination section 230 judges whether the demagnetization amount is equal to or less than an allowable value. When the demagnetization amount exceeds the allowable value, the determination section 230 determines that the magnet is to be re-magnetized, and the processing is caused to proceed to S618. When the demagnetization amount is equal to or less than the allowable value, the determination section 230 determines in S618 that the rotor is to be reused, and the processing of this flowchart is ended.

When it is determined in the judgment of S610 that the load of the rotor exceeds the threshold set for the rotor, the determination section 230 determines in S620 that the rotor is to be recycled.

FIG. 7 is an example of a flowchart relating to a reuse determination method of the stator. The processing of this flowchart can be applied to the processing of S504 in FIG. 5. In S702, the estimation section 220 generates temperature frequency information. The temperature frequency information is calculated based on the temperature data. The temperature frequency information is information indicating a correspondence relationship between a temperature and a time. In S704, the estimation section 220 estimates a load of the resin member constituting the stator, based on the temperature frequency information. For example, the estimation section 220 estimates a cumulative damage degree of the resin member.

In S706, the determination section 230 judges whether the load of the resin member constituting the stator is equal to or less than a threshold set for the resin member. When the load of the resin member is equal to or less than the threshold, the determination section 230 determines in S708 that the stator is to be reused, and the processing of this flowchart is ended. When the load of the resin member exceeds the threshold, the determination section 230 determines in S710 that the stator is to be recycled, and the processing of this flowchart is ended. When it is determined that the stator is to be recycled, the steel plate and windings of the stator are to be recycled.

As described above, according to the reuse determination system 40, it is possible to determine whether to reuse the entire power unit 12 or each component of the rotating electrical machine 30, taking into consideration the past load of each component of the gearbox 20 and the rotating electrical machine 30. For this reason, it is possible to determine whether to reuse the power unit 12 and the rotating electrical machine 30, taking into consideration a deterioration state and a remaining lifetime of each component. Thereby, it is possible to suppress the power unit 12 and the rotating electrical machine 30 from being uselessly brought on recycling without being reused.

Note that, the vehicle 10 is an example of transportation equipment. The transportation equipment includes an automobile such as a passenger car and a bus, and a saddle-ride vehicle. The transportation equipment is an example of the mobile object. The reuse determination system 40 can be applied to the reuse determination of a power unit provided to an arbitrary mobile object.

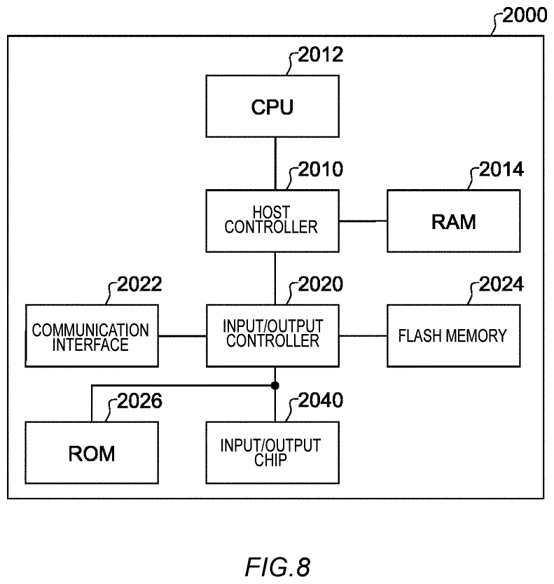

FIG. 8 shows an example of a computer 2000 where a plurality of embodiments of the present invention may be entirely or partially embodied. A program that is installed in the computer 2000 can cause the computer 2000 to function as a system such as the reuse determination system 40 of the embodiment or each section of the system, to execute operations associated with the system or each section of the system and/or to execute the process of the embodiment or steps thereof. Such program may be executed by a CPU 2012 so as to cause the computer 2000 to execute certain operations associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 is configured to operate according to programs stored in the ROM 2026 and the RAM 2014, thereby controlling each unit.

The communication interface 2022 is configured to communicate with other electronic devices via a network. The flash memory 2024 is configured to store a program and data that are used by the CPU 2012 in the computer 2000. The ROM 2026 is configured to store a boot program or the like that is executed by the computer 2000 at the time of activation, and/or a program depending on hardware of the computer 2000. The input/output chip 2040 may also be configured to connect various input and output units such as a keyboard, a mouse, and a monitor, to the input/output controller 2020 via input and output ports such as a serial port, a parallel port, a keyboard port, a mouse port, a monitor port, a USB port and an HDMI (registered trademark) port.

A program is provided via a computer readable medium such as a CD-ROM, a DVD-ROM, or a memory card, or a network. The RAM 2014, the ROM 2026, or the flash memory 2024 is an example of the computer readable medium. The program is installed in the flash memory 2024, the RAM 2014 or the ROM 2026 and is executed by the CPU 2012. The information processing described in these programs is read into the computer 2000, resulting in cooperation between a program and the various types of hardware resources described above. An apparatus or a method may be constituted by realizing an operation or processing of information according to a use of the computer 2000.

For example, when communication is performed between the computer 2000 and an external apparatus, the CPU 2012 may be configured to execute a communication program loaded onto the RAM 2014 to instruct communication processing to the communication interface 2022, based on processing described in the communication program. The communication interface 2022 is configured, under control of the CPU 2012, to read transmission data stored on a transmission buffer processing area provided in a recording medium such as the RAM 2014 and the flash memory 2024, to transmit the read transmission data to the network, and to write reception data received from the network to a reception buffer processing area or the like provided on the recording medium.

In addition, the CPU 2012 may be configured to cause all or a necessary portion of a file or a database, which has been stored in a recording medium such as the flash memory 2024, to be read into the RAM 2014, thereby executing various types of processing on the data on the RAM 2014. Next, the CPU 2012 is configured to write the processed data back to the recording medium.

Various types of information, such as various types of programs, data, tables, and databases, may be stored in the recording medium to undergo information processing. The CPU 2012 may be configured to execute, on the data read from the RAM 2014, various types of processing including various types of operations, processing of information, condition judging, conditional branching, unconditional branching, search and replacement of information, and the like described in the present specification and specified by instruction sequences of the programs, and to write a result back to the RAM 2014. In addition, the CPU 2012 may be configured to search for information in a file, a database and the like in the recording medium. For example, when a plurality of entries, each having an attribute value of a first attribute associated with an attribute value of a second attribute, are stored in the recording medium, the CPU 2012 may be configured to search for an entry matching the condition whose attribute value of the first attribute is designated, from the plurality of entries, and to read the attribute value of the second attribute stored in the entry, thereby acquiring the attribute value of the second attribute associated with the first attribute satisfying a predetermined condition.

The programs or software modules described above may be stored in the computer-readable medium on the computer 2000 or near the computer 2000. A recording medium such as a hard disk or a RAM provided in a server system connected to a dedicated communication network or the Internet can be used as a computer readable medium. The program stored in the computer readable medium may be provided to the computer 2000 via the network.

A program that is installed in the computer 2000 and causes the computer 2000 to function as the processing section 200 may work on the CPU 2012 and the like to cause the computer 2000 to function as each section of the processing section 200, respectively. The information processing described in these programs are read into the computer 2000 to cause the computer to function as each section of the processing section 200, which is a specific means realized by cooperation of software and the various types of hardware resources described above. Then, with these specific means, by realizing computing or processing of information according to an intended use of the computer 2000 in the present embodiment, the specific processing section 200 is constructed according to the intended use.

Various embodiments have been described with reference to the block diagrams and the like. In the block diagrams, each block may represent (1) a step of a process in which an operation is executed, or (2) each section of an apparatus responsible for executing the operation. Certain steps and each section may be implemented by dedicated circuitry, programmable circuitry supplied with computer readable instructions stored on computer readable media, and/or processors supplied with computer readable instructions stored on computer readable media. The dedicated circuitry may include a digital and/or analog hardware circuit, or may include an integrated circuit (IC) and/or a discrete circuit. The programmable circuitry may include a reconfigurable hardware circuit including logical AND, logical OR, logical XOR, logical NAND, logical NOR, and other logical operations, a flip-flop, a register, a memory element such as a field programmable gate array (FPGA) and a programmable logic array (PLA), and the like.

Computer readable media may include any tangible device that can store instructions to be executed by a suitable device, and as a result, the computer readable medium having the instructions stored thereon constitutes at least a part of an article of manufacture including instructions that can be executed to provide means for performing operations specified in the processing procedures or block diagrams. Examples of computer readable media may include an electronic storage medium, a magnetic storage medium, an optical storage medium, an electromagnetic storage medium, a semiconductor storage medium, and the like. More specific examples of computer readable media may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a BLU-RAY (registered trademark) disk, a memory stick, an integrated circuit card, and the like.

Computer readable instructions may include assembler instructions, instruction-set-architecture (ISA) instructions, machine instructions, machine dependent instructions, microcode, firmware instructions, state-setting data, or either source code or object code described in any combination of one or more programming languages, including an object oriented programming language such as Smalltalk (registered trademark), JAVA (registered trademark) and C++, and a conventional procedural programming language such as a ‘C’ programming language or similar programming languages.

Computer readable instructions may be provided to a processor of a general purpose computer, a special purpose computer, or another programmable data processing apparatus, or to programmable circuitry, locally or via a local area network (LAN), wide area network (WAN) such as the Internet, and the like, and the computer readable instructions may be executed to create means for performing operations specified in the described processing procedures or block diagrams. Examples of a processor include a computer processor, a processing unit, a microprocessor, a digital signal processor, a controller, a microcontroller, and the like.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: vehicle
12: power unit
20: gearbox
30: rotating electrical machine
40: reuse determination system
50: operation history collection server
80, 90: vehicle
200: processing section
210: acquisition section
220: estimation section
230: determination section
290: storage section
2000: computer
2010: host controller
2012: CPU
2014: RAM
2020: input/output controller
2022: communication interface
2024: flash memory
2026: ROM
2040: input/output chip

What is claimed is:

1. A reuse determination system of a power unit for propelling a vehicle,
the power unit including at least:
a rotating electrical machine; and
a gearbox having a power transmission device, a housing configured to accommodate at least the power transmission device, and a transmission device for transmitting power from the rotating electrical machine and the power transmission device to a driven part,
the reuse determination system comprising:
an acquisition section configured to acquire operation history data including torque data and number of rotations data of the rotating electrical machine;
an estimation section configured to estimate a load of each of a plurality of components constituting the power unit, based on at least one of the torque data or the number of rotations data; and
a determination section configured to:
compare, for each of the plurality of components constituting the power unit, each load estimated by the estimation section with a threshold set for each of the plurality of components, and
determine
that the power unit is to be reused, when the load of each of the plurality of components estimated by the estimation section is equal to or less than the threshold set for each of the plurality of components, and
that the power unit is to be subjected to component replacement and to be reused, when there exists a component for which a load exceeding the threshold set for each of the plurality of components is estimated among the plurality of components.

2. The reuse determination system according to claim 1, wherein
the estimation section is configured to estimate a load of each of the power transmission device, the housing and the transmission device, based on the torque data and the number of rotations data, and
the determination section is configured to:
compare, for each of the power transmission device, the housing and the transmission device, each load estimated by the estimation section with a threshold set for each of the power transmission device, the housing and the transmission device, and
determine that the gearbox is to be reused, when the load of each of the power transmission device, the housing and the transmission device is equal to or less than the threshold set for each of the power transmission device, the housing and the transmission device, and determine that the gearbox is to be subjected to component replacement and to be reused, when the load of at least one of the power transmission device, the housing or the transmission device exceeds the threshold.

3. The reuse determination system according to claim 2, wherein
the determination section is configured to determine that the gearbox is not to be reused, when a load of each of members, whose number exceeds a predetermined number, of the power transmission device, the housing, and the transmission device exceeds the threshold set for each of the members.

4. The reuse determination system according to claim 1, wherein
the determination section is configured to acquire, based on the torque data, a number of times that a torque of the rotating electrical machine exceeds a predetermined torque value and to determine that the gearbox is not to be reused, when the number of times that the predetermined torque value is exceeded exceeds a predetermined allowable value.

5. The reuse determination system according to claim 1, wherein
the estimation section is configured to acquire a number of times that a number of rotations of the rotating electrical machine exceeds a predetermined number of rotations, based on the number of rotations data and to estimate a load of a component constituting the rotating electrical machine, based on the number of times, and
the determination section is configured to determine
that the rotating electrical machine is to be reused, when the load of the component constituting the rotating electrical machine is equal to or less than a predetermined threshold, and
that the rotating electrical machine is not to be reused, when the load of the component constituting the rotating electrical machine exceeds the threshold.

6. The reuse determination system according to claim 2, wherein
the estimation section is configured to acquire a number of times that a number of rotations of the rotating electrical machine exceeds a predetermined number of rotations, based on the number of rotations data and to estimate a load of a component constituting the rotating electrical machine, based on the number of times, and
the determination section is configured to determine
that the rotating electrical machine is to be reused, when the load of the component constituting the rotating electrical machine is equal to or less than a predetermined threshold, and that the rotating electrical machine is not to be reused, when the load of the component constituting the rotating electrical machine exceeds the threshold, and
that the power unit is to be reused, when it is determined that the rotating electrical machine and the gearbox are to be reused.

7. The reuse determination system according to claim 2, wherein
the estimation section is configured to acquire a number of times that a number of rotations of the rotating electrical machine exceeds a predetermined number of rotations, based on the number of rotations data and to estimate a load of a rotor provided to the rotating electrical machine, based on the number of times, and
the determination section is configured to determine
that the rotor is to be reused, when the load of the rotor is equal to or less than a predetermined threshold, and
that the rotor is not to be reused, when a load of the rotor exceeds the threshold.

8. The reuse determination system according to claim 7, wherein
the operation history data further includes current data and temperature data of the rotating electrical machine,
the estimation section is configured to estimate a demagnetization amount of a magnet included in the rotor, further based on the current data and the temperature data, and
the determination section is configured to determine that the rotor is to be reused, when the load of the rotor is equal to or less than a predetermined threshold and the demagnetization amount of the magnet is equal to or less than a predetermined threshold.

9. The reuse determination system according to claim 7, wherein
the operation history data further includes temperature data of the rotating electrical machine,
the estimation section is configured to estimate a load of a resin member provided to a stator included in the rotating electrical machine, based on the temperature data, and
the determination section is configured to determine
that the stator is to be reused, when the load of the resin member is equal to or less than a predetermined threshold, and
that the stator is not to be reused, when the load of the resin member exceeds the threshold.

10. The reuse determination system according to claim 9, wherein
the determination section is configured to determine that the rotating electrical machine is to be reused, when it is determined that the rotor and the stator are to be reused.

11. The reuse determination system according to claim 1, wherein
the transmission device includes at least one of a drive shaft or a bearing.

12. The reuse determination system according to claim 1, wherein
the determination section is configured to decide a reuse destination of the power unit determined to be reused, based on the load of each of the plurality of components estimated by the estimation section.

13. The reuse determination system according to claim 2, wherein
the determination section is configured to acquire a number of times that torque of the rotating electrical machine exceeds a predetermined torque value, based on the torque data, and to determine that the gearbox is not to be reused, when the number of times that the predetermined torque value is exceeded exceeds a predetermined allowable value.

14. The reuse determination system according to claim 3, wherein
the determination section is configured to acquire, based on the torque data, a number of times that a torque of the rotating electrical machine exceeds a predetermined torque value and to determine that the gearbox is not to be reused, when the number of times that the predetermined torque value is exceeded exceeds a predetermined allowable value.

15. The reuse determination system according to claim 2, wherein
the estimation section is configured to acquire a number of times that a number of rotations of the rotating electrical machine exceeds a predetermined number of rotations, based on the number of rotations data and to estimate a load of a component constituting the rotating electrical machine, based on the number of times, and
the determination section is configured to determine
that the rotating electrical machine is to be reused, when the load of the component constituting the rotating electrical machine is equal to or less than a predetermined threshold, and
that the rotating electrical machine is not to be reused, when the load of the component constituting the rotating electrical machine exceeds the threshold.

16. The reuse determination system according to claim 3, wherein
the estimation section is configured to acquire a number of times that a number of rotations of the rotating electrical machine exceeds a predetermined number of rotations, based on the number of rotations data and to estimate a load of a component constituting the rotating electrical machine, based on the number of times, and
the determination section is configured to determine
that the rotating electrical machine is to be reused, when the load of the component constituting the rotating electrical machine is equal to or less than a predetermined threshold, and that the rotating electrical machine is not to be reused, when the load of the component constituting the rotating electrical machine exceeds the threshold, and
that the power unit is to be reused, when it is determined that the rotating electrical machine and the gearbox are to be reused.

17. The reuse determination system according to claim 3, wherein
the estimation section is configured to acquire a number of times that a number of rotations of the rotating electrical machine exceeds a predetermined number of rotations, based on the number of rotations data and to estimate a load of a rotor provided to the rotating electrical machine, based on the number of times, and
the determination section is configured to determine
that the rotor is to be reused, when the load of the rotor is equal to or less than a predetermined threshold, and
that the rotor is not to be reused, when a load of the rotor exceeds the threshold.

18. The reuse determination system according to claim 17, wherein
the operation history data further includes current data and temperature data of the rotating electrical machine,
the estimation section is configured to estimate a demagnetization amount of a magnet included in the rotor, further based on the current data and the temperature data, and
the determination section is configured to determine that the rotor is to be reused, when the load of the rotor is equal to or less than a predetermined threshold and the demagnetization amount of the magnet is equal to or less than a predetermined threshold.

19. A reuse determination method of a power unit for propelling a vehicle,
the power unit including at least:
a rotating electrical machine; and
a gearbox having a power transmission device, a housing configured to accommodate at least the power transmission device, and a transmission device for transmitting power from the rotating electrical machine and the power transmission device to a driven part,
the reuse determination method comprising:
acquiring operation history data including torque data and number of rotations data of the rotating electrical machine;
estimating a load of each of a plurality of components constituting the power unit, based on at least one of the torque data or the number of rotations data;
for each of the plurality of components constituting the power unit, comparing each of the loads estimated, with a threshold set for each of the plurality of components, and
determining that the power unit is to be reused, when the load estimated of each of the plurality of components is equal to or less than the threshold set for each of the plurality of components, and that the power unit is to be subjected to component replacement and to be reused, when there exists a component for which a load exceeding the threshold set for each of the plurality of components is estimated among the plurality of components.

20. A non-transitory computer readable storage medium having stored thereon a program for a reuse determination system of a power unit for propelling a vehicle,
the power unit including at least:
a rotating electrical machine; and
a gearbox having a power transmission device, a housing configured to accommodate at least the power transmission device, and a transmission device for transmitting power from the rotating electrical machine and the power transmission device to a driven part,
the program being configured to cause a computer to function as:
an acquisition section configured to acquire operation history data including torque data and number of rotations data of the rotating electrical machine;
an estimation section configured to estimate a load of each of a plurality of components constituting the power unit, based on at least one of the torque data or the number of rotations data; and
a determination section configured to:
compare, for each of the plurality of components constituting the power unit, each load estimated by the estimation section with a threshold set for each of the plurality of components, and
determine
that the power unit is to be reused, when the load of each of the plurality of components estimated by the estimation section is equal to or less than the threshold set for each of the plurality of components, and
that the power unit is to be subjected to component replacement and to be reused, when there exists a component for which a load exceeding the threshold set for each of the plurality of components is estimated among the plurality of components.
